(19) United States
(12) Patent Application Publication
(10) Pub. No.: US 2025/0381933 A1
(43) Pub. Date: Dec. 18, 2025

(54) WIPING DEVICE

(71) Applicant: MITSUBA Corporation, Gunma (JP)

(72) Inventors: TOSHIYUKI AMAGASA, Gunma (JP); TSUNEO SUGIYAMA, Gunma (JP); HIDEYUKI KOIZUMI, Gunma (JP); HIDEKI TAMEGAI, Gunma (JP); NOBUTAKA NAKAJIMA, Gunma (JP)

(73) Assignee: MITSUBA Corporation, Gunma (JP)

(21) Appl. No.: 19/230,019

(22) Filed: Jun. 5, 2025

(30) Foreign Application Priority Data
Jun. 12, 2024 (JP) 2024-095421

(51) Int. Cl. B60S 1/08

(52) U.S. Cl. CPC B60S 1/0814

(57) ABSTRACT

Provided is a wiping device. The wiping device includes a pair of wiper blades that reciprocate between a lower inversion position and an upper inversion position on a wiped surface; a pair of motors that drive the pair of wiper blades respectively; and a control unit that controls the pair of motors. The control unit estimates a load of one of the motors that drives, among the pair of wiper blades, one wiper blade that moves first at operation start as a load estimation amount, and corrects the upper inversion position in a direction closer to the lower inversion position based on the load estimation amount.

### CROSS-REFERENCE TO RELATED APPLICATION

This application claims the priority benefits of Japanese application no. 2024-095421, filed on Jun. 12, 2024. The entirety of the above-mentioned patent application is hereby incorporated by reference herein and made a part of this specification.

### BACKGROUND

### Technical Field

The disclosure relates to a wiping device.

### Related Art

In Japanese Patent Application Laid-Open Publication No. 2015-27859, a wiper device capable of improving wiping performance of a wiper and suppress deterioration of durability of a rotor shaft and a worm wheel. The wiper device transmits torque of an electric motor to the wiper via a torque transmission mechanism, and wipes a wiping surface of an object by reciprocating the wiper. It includes a controller that switches between a low torque control for outputting low torque from the electric motor to reciprocate the wiper and a high torque control for outputting high torque from the electric motor to reciprocate the wiper when reciprocating the wiper multiple times.

### CITATION LIST

### Patent Document

[Patent Document 1] Japanese Patent Application Laid-Open Publication No. 2015-27859

Incidentally, for example, when water splashes from a vehicle traveling ahead adhere to a wiping surface, or when a washer operates on a fine day, the friction coefficient of the wiping surface suddenly decreases. In this case, the load of the wiper device changes rapidly from a high state to a low state. Therefore, in the case of reciprocating the wiper (wiper blade) with high torque control, there is a risk that the wiper blade may overrun at the inversion position and interfere with the pillar.

The disclosure is made in view of the above circumstances, and aims to provide a wiping device capable of suppressing overrun of the wiper blade.

### SUMMARY

A wiping device includes a pair of wiper blades that reciprocate between a lower inversion position and an upper inversion position on a wiped surface; a pair of motors that drive the pair of wiper blades respectively; and a control unit that controls the pair of motors, in which the control unit estimates a load of one of the motors that drives, among the pair of wiper blades, one of the wiper blades that moves first at operation start as a load estimation amount, and corrects the upper inversion position in a direction closer to the lower inversion position based on the load estimation amount.

### BRIEF DESCRIPTION OF THE DRAWINGS

FIG. 1 is a block diagram showing the functional configuration of a wiping device according to an embodiment of the disclosure.

FIG. 2 is a first flowchart showing the operation of a wiping device according to an embodiment of the disclosure.

FIG. 3 is a second flowchart showing the operation of a wiping device according to an embodiment of the disclosure.

FIG. 4 is a third flowchart showing the operation of a wiping device according to an embodiment of the disclosure.

### DESCRIPTION OF THE EMBODIMENTS

The following describes an embodiment of the disclosure with reference to the drawings.

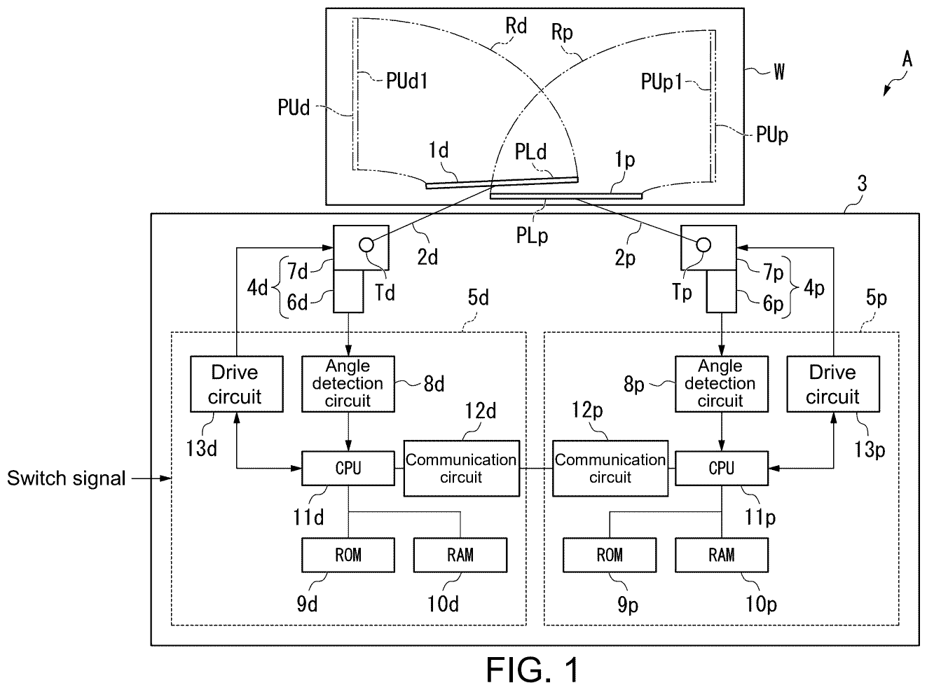

A wiping device A according to the embodiment includes, as shown in FIG. 1, a pair of wiper blades 1d, 1p, a pair of wiper arms 2d, 2p, and a drive control device 3. The drive control device 3 includes, as shown, a pair of motors 4d, 4p and a pair of wiper drive control units 5d, 5p.

In the reference numerals in FIG. 1, “d” indicates members or parts related to the driver's side of the vehicle. Moreover, “p” indicates members or parts related to the passenger's side of the vehicle. In FIG. 1, reference numeral Rd is the wiping range (driver's seat wiping range) of the wiper blade 1d on the driver's side. Moreover, reference numeral Rp is the wiping range (passenger seat wiping range) of the wiper blade 1p on the passenger's side.

Such wiping device A is mounted on various mobile vehicles such as gasoline vehicles, hybrid vehicles, or electric vehicles, and wipes off rainwater adhering to a surface (wiped surface W) of wiped members such as front glass or rear glass. That is, the wiping device A includes a pair of motors 4d, 4p and a pair of wiper drive control units 5d, 5p corresponding to the pair of wiper arms 2d, 2p. The pair of wiper drive control units 5d, 5p correspond to the control unit in the disclosure.

Moreover, the wiping device A performs opposed wiping mode (opposite manner) that makes the pair of wiper blades 1d, 1p reciprocate in opposition to each other as shown, but it may also be configured to make the pair of wiper blades 1d, 1p reciprocate in the opposed wiping mode (opposite manner) or a parallel wiping mode (tandem manner) that makes the pair of wiper blades 1d, 1p reciprocate in parallel by switching between the opposite manner and the parallel wiping mode (tandem manner) through control.

In the opposed wiping mode (opposite manner), when one wiper arm 2d provided on the driver's side moves upward from bottom to top, the other wiper arm 2p provided on the passenger's side also moves upward from bottom to top, similar to the wiper arm 2d on the driver's side. Moreover, when the wiper arm 2d on the driver's side moves downward from top to bottom, the wiper arm 2p on the passenger's side also moves downward from top to bottom.

A driver's seat wiping range Rd is a range extending from a lower inversion position PLd on the driver's side to an upper inversion position PUd on the driver's side as the movement trajectory of the wiper blade 1d on the driver's side. The lower inversion position PLd on the driver's side is the position where the wiper blade 1d on the driver's side inverts from downward movement to upward movement. Moreover, the upper inversion position PUd on the driver's side is the position where the wiper blade 1d on the driver's side inverts from upward movement to downward movement.

A passenger seat wiping range Rp is a range extending from a lower inversion position PLp on the passenger's side to an upper inversion position PUp on the passenger's side as the movement trajectory of the wiper blade 1p on the passenger's side. The lower inversion position PLp on the passenger's side is the position where the wiper blade 1p on the passenger's side inverts from downward movement to upward movement. Moreover, the upper inversion position PUp on the passenger's side is the position where the wiper blade 1p on the passenger's side inverts from downward movement to upward movement.

Here, the standby positions of the pair of wiper blades 1d, 1p are the lower inversion positions PLd, PLp as shown. In the standby position, that is, at the lower inversion positions PLd, PLp, the wiper blade 1d on the driver's side is positioned above the wiper blade 1p on the passenger's side. Therefore, the wiper blade 1d on the driver's side starts moving ahead of the wiper blade 1p on the passenger's side at operation start.

Moreover, in FIG. 1, reference numerals PUd1, PUp1 indicate correction upper inversion positions in the pair of wiper blades 1d, 1p. That is, the reference numeral PUd1 is the correction upper inversion position for the wiper blade 1d on the driver's side. On the other hand, the reference numeral PUp1 is the correction upper inversion position for the wiper blade 1p on the passenger's side.

The pair of wiper blades 1d, 1p are rod-shaped members placed on the wiped surface W as shown. The pair of wiper blades 1d, 1p are in contact with the wiped surface W, and wipe rain water existing on the wiped surface by reciprocating between the lower inversion positions PLd, PLp and the upper inversion positions PUd, PUp on the wiped surface W. Such pair of wiper blades 1d, 1p are mechanically connected respectively to of the pair of motors 4d, 4p via the pair of wiper arms 2d, 2p.

That is, the wiper blade 1d on the driver's side is connected to the motor 4d on the driver's side via the wiper arm 2d provided on the driver's side. The wiper blade 1p on the passenger's side is connected to the motor 4p on the passenger's side via the wiper arm 2p provided on the passenger's side.

The pair of wiper arms 2d, 2p are rod-shaped members as shown, with one end connected to intermediate parts of the pair of wiper blades 1d, 1p, and the other end connected to a pair of wiper shafts Td, Tp. That is, the wiper arm 2d on the driver's side has one end connected to an intermediate part of the wiper blade 1d on the driver's side, and the other end connected to the wiper shaft Td on the driver's side.

On the other hand, the wiper arm 2p on the passenger's side has one end connected to an intermediate part of the wiper blade 1p on the passenger's side, and the other end connected to the wiper shaft Tp on the passenger's side. The pair of wiper arms 2d, 2p are members included in the components of the pair of wiper blades 1d, 1p. Such pair of wiper arms 2d, 2p function as power transmission parts that individually transmit turning power from the pair of motors 4d, 4p to the pair of wiper blades 1d, 1p.

That is, the wiper arm 2d on the driver's side transmits turning power from the motor 4d on the driver's side to the wiper blade 1d on the driver's side. The wiper arm 2p on the passenger's side transmits turning power from the motor 4p on the passenger's side to the wiper blade 1p on the passenger's side. In addition, such pair of wiper arms 2d, 2p also function as biasing members that press the pair of wiper blades 1d, 1p against the wiped surface W with a predetermined pressing force.

Among the pair of motors 4d, 4p, the motor 4d on the driver's side is the power source on the driver's side that causes the wiper blade 1d on the driver's side corresponding to itself to perform reciprocating motion. The motor 4d includes a motor body 6d and a deceleration mechanism 7d. Moreover, the motor 4p on the passenger's side is the power source on the passenger's side that causes the wiper blade 1p on the passenger's side corresponding to itself to perform reciprocating motion. The motor 4p includes a motor body 6p and a deceleration mechanism 7p.

Moreover, among the pair of wiper drive control units 5d, 5p, the first wiper drive control unit 5d includes an angle detection circuit 8d, a ROM (Read Only Memory) 9d, a RAM (Random Access Memory) 10d, a CPU (Central Process Unit) 11d, a communication circuit 12d and a drive circuit 13d, and performs drive control of the motor 4d on the driver's side.

On the other hand, the second wiper drive control unit 5p includes an angle detection circuit 8p, a ROM (Read Only Memory) 9p, a RAM (Random Access Memory) 10p, a CPU (Central Process Unit) 11p, a communication circuit 12p and a drive circuit 13p, and performs drive control of the motor 4p on the passenger's side.

Among such pair of wiper drive control units 5d, 5p, the first wiper drive control unit 5d is a drive control unit corresponding to the motor 4d on the driver's side. On the other hand, the second wiper drive control unit 5p is a drive control unit corresponding to the motor 4p on the passenger's side.

The first wiper drive control unit 5d causes the wiper blade 1d on the driver's side to perform reciprocating motion (oscillating motion) around the wiper shaft Td by performing drive control of the motor 4d on the driver's side. The second wiper drive control unit 5p causes the wiper blade 1p on the passenger's side to perform reciprocating motion (oscillating motion) around the wiper shaft Tp by performing drive control of the motor 4p on the passenger's side.

In such first wiper drive control unit 5d, the angle detection circuit 8d on the driver's side outputs an angle signal proportional to the rotation angle of the motor 4d on the driver's side to the CPU 11d on the driver's side. The angle signal is a signal indicating an operating angle of the wiper blade 1d on the driver's side, and includes the relative position signal and the absolute position signal described in the first embodiment.

The above relative position signal is a pulse signal (motor pulse) generated in accordance with the rotation of the motor 4d on the driver's side, and is a pulse signal (pulse train) with a number of pulses proportional to the rotation angle of the motor 4d on the driver's side. In contrast, the absolute position signal is a single pulse signal emitted when the pair of wiper blades 1d, 1p reach a control reference position. The control reference position is, for example, the lower inversion position PLd, PLp.

A ROM 9d on the driver's side is a non-volatile memory. The ROM 9d stores a control program for the CPU 11d to perform feedback control of the wiper blade 1d on the driver's side. Moreover, the ROM 9d stores an operation map that the CPU 11d on the driver's side references when executing the control program.

The above operation map indicates a target speed of the wiper blade 1d on the driver's side in the driver's seat wiping range Rd. The RAM 10d on the driver's side is a volatile memory. The RAM 10d temporarily stores various data generated when the CPU 11d executes the control program.

The CPU 11d on the driver's side generates a drive command by executing the control program previously stored in the ROM 9d on the driver's side, and outputs the drive command to the drive circuit 13d on the driver's side. The CPU 11d, in executing the control program, references the switch signal input from an upper control device, the angle signal input from the angle detection circuit 8d, the control information input from the communication circuit 12d on the driver's side, and the operation map previously stored in the ROM 9d.

In other words, the CPU 11d generates a drive command by referencing the switch signal, angle signal, control information, and operation map based on the control program. The drive command is a control instruction that instructs the drive circuit 13d on the driver's side to drive the wiper blade 1d on the driver's side while considering the drive control state of the wiper blade 1p on the passenger's side in the second wiper drive control unit 5p.

The drive command is intended to control the wiper blade 1d on the driver's side such that the movement speed of the wiper blade 1d on the driver's side obtained from the angle signal is equal to the target speed of the operation map, and synchronizes with the movement of the wiper blade 1p on the passenger's side. Such a drive command is, for example, a PWM signal.

The above switch signal is an upper control command that instructs the wiping device A regarding the ON/OFF (Lo operation, Hi operation, etc.) of the wiper switch provided in the vehicle, designation of heavy rain mode, ON/OFF of the mist switch, intermittent operation (Lo, Hi, INT operation), etc. Moreover, the above drive command is, for example, a PWM (Pulse Width Modulation) signal, and is a control instruction that operates the CPU 11d on the driver's side and the CPU lip on the passenger's side based on the duty ratio, which is an attribute information, that is, the ratio between the Hi (high) period and the Lo (low) period in the step signal.

Here, CPU 11d controls the wiper blade 1d on the driver's side as its control target, and performs load estimation of the motor 4d on the driver's side corresponding to the same wiper blade 1d on the driver's side based on the angle signal input from the angle detection circuit 8d, etc. The CPU 11d performs correction process related to the upper inversion position PUd of the wiper blade 1d on the driver's side based on the load estimation result of the motor 4d on the driver's side. Moreover, the CPU 11d provides the load estimation result of the motor 4d on the driver's side to the CPU 11p on the passenger's side as control information via the communication circuit 12d on the driver's side.

The communication circuit 12d on the driver's side sends and receives control information to and from the second wiper drive control unit 5p. The communication circuit 12d on the driver's side receives, as the control information, for example, the current position of the wiper blade 1p on the passenger's side from the communication circuit 12p of the second wiper drive control unit 5p. Moreover, the communication circuit 12d on the driver's side transmits, as the control information, for example, the current position of the wiper blade 1d on the driver's side to the communication circuit 12p of the second wiper drive control unit 5p.

The drive circuit 13d on the driver's side is a three-phase inverter circuit that includes multiple switching transistors. The drive circuit 13d on the driver's side generates a U-phase drive signal, a V-phase drive signal, and a W-phase drive signal by sequentially operating a U-phase switching leg, a V-phase switching leg, and a W-phase switching leg based on the first to sixth PWM signals input from the CPU 11d on the driver's side.

The drive circuit 13d on the driver's side outputs the U-phase drive signal from a U-phase output terminal to a first input terminal of the motor 4d on the driver's side. Moreover, the drive circuit 13d on the driver's side outputs the V-phase drive signal from a V-phase output terminal to a second input terminal of the motor 4d on the driver's side. Furthermore, the drive circuit 13d on the driver's side outputs the W-phase drive signal from a W-phase output terminal to a third input terminal of the motor 4d on the driver's side.

On the other hand, in the second wiper drive control unit 5p, the angle detection circuit 8p on the passenger's side outputs an angle signal proportional to the rotation angle of the motor 4p on the passenger's side to the CPU lip on the passenger's side. The angle signal indicates an operating angle of the wiper blade 1p on the passenger's side, and includes a relative position signal and an absolute position signal.

The relative position signal is a pulse signal (motor pulse) generated in accordance with the rotation of the motor 4p on the passenger's side, and is a pulse signal (pulse train) with a number of pulses proportional to the rotation angle of the motor 4p on the passenger's side. In contrast, the absolute position signal is a single pulse signal emitted when the pair of wiper blades 1d, 1p reach the control reference position. The control reference position is, for example, the lower inversion position PLd, PLp.

A ROM 9p on the passenger's side is a non-volatile memory. The ROM 9p stores a control program for the CPU 11p on the passenger's side to perform feedback control of the wiper blade 1p on the passenger's side. Moreover, the ROM 9p stores an operation map necessary for the CPU 11p on the passenger's side to execute the control program.

The operation map indicates the target speed of the wiper blade 1p on the passenger's side in the passenger seat wiping range Rp. The control program stored in the ROM 9p is substantially the same with the control program stored in the ROM 9d of the first wiper drive control unit 5d. The RAM 10p on the passenger's side is a volatile memory. The RAM 10p temporarily stores various data generated when the CPU 11p on the passenger's side executes the control program.

The CPU lip on the passenger's side generates a drive command by executing the control program previously stored in the ROM 9p on the passenger's side, and outputs the drive command to the drive circuit 13p on the passenger's side. The CPU 11p, in executing the control program, references the switch signal input from the upper control device, the angle signal input from the angle detection circuit 8p, the control information input from the communication circuit 12p, and the operation map previously stored in the ROM 9p.

In other words, the CPU 11p generates a drive command by referring to the switch signal, angle signal, control information, and operation map based on the control program. The drive command is a control instruction that instructs the drive circuit 13p on the passenger's side to drive the wiper blade 1p on the passenger's side while taking into account the drive control state of the wiper blade 1d on the driver's side in the first wiper drive control unit 5d.

The drive command is intended to control the wiper blade 1p on the passenger's side such that the movement speed of the wiper blade 1p on the passenger's side obtained from the angle signal becomes equal to the target speed of the operation map, and synchronizes with the movement of the wiper blade 1d on the driver's side. The drive command is a PWM signal, similar to the drive command on the driver's side.

Here, the CPU 11p on the passenger's side controls the wiper blade 1p on the passenger's side as its control target, and performs correction process related to the upper inversion position PUp of the wiper blade 1p on the passenger's side based on the load estimation result of the motor 4d on the driver's side provided from the CPU 11d. In other words, the CPU lip corrects the upper inversion position PUp of the wiper blade 1p on the passenger's side based on the load state of the motor 4d on the driver's side that drives the wiper blade 1d on the driver's side.

The communication circuit 12p on the passenger's side sends and receives control information to and from the first wiper drive control unit 5d. The communication circuit 12p on the passenger's side receives, as the control information, for example, the current position of the wiper blade 1d on the driver's side from the communication circuit 12d on the driver's side. Moreover, the communication circuit 12p on the passenger's side transmits, as the control information, for example, the current position of the wiper blade 1p on the passenger's side to the communication circuit 12d on the driver's side.

The drive circuit 13p on the passenger's side is a three-phase inverter circuit including multiple switching transistors, similar to the drive circuit 13d on the driver's side. The drive circuit 13p on the passenger's side generates a U-phase drive signal, a V-phase drive signal, and a W-phase drive signal by sequentially operating a U-phase switching leg, a V-phase switching leg, and a W-phase switching leg based on the first to sixth PWM signals input from the CPU 11p on the passenger's side.

The drive circuit 13p on the passenger's side outputs the U-phase drive signal from a U-phase output terminal to a first input terminal of the motor 4p on the passenger's side. Moreover, the drive circuit 13p on the passenger's side outputs the V-phase drive signal from a V-phase output terminal to a second input terminal of the motor 4p on the passenger's side. Furthermore, the drive circuit 13p on the passenger's side outputs the W-phase drive signal from a W-phase output terminal to a third input terminal of the motor 4p on the passenger's side.

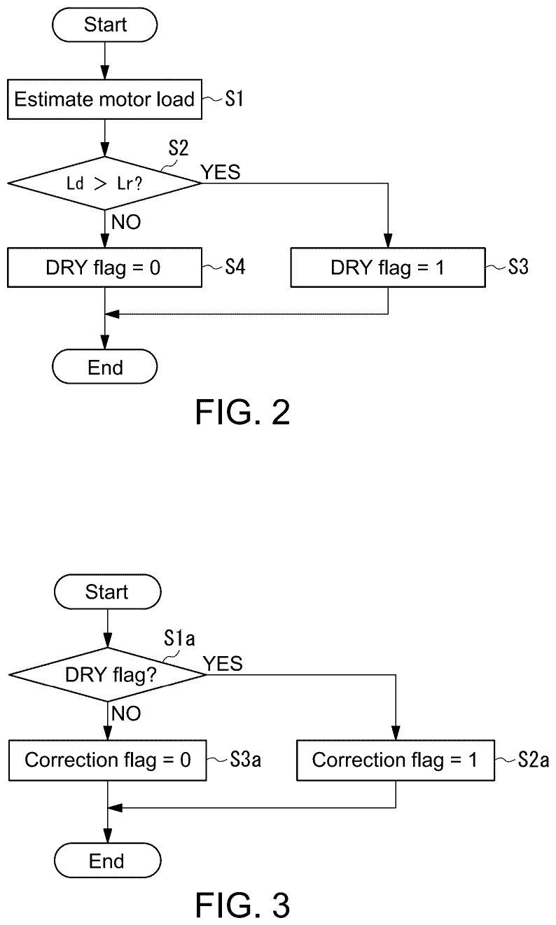

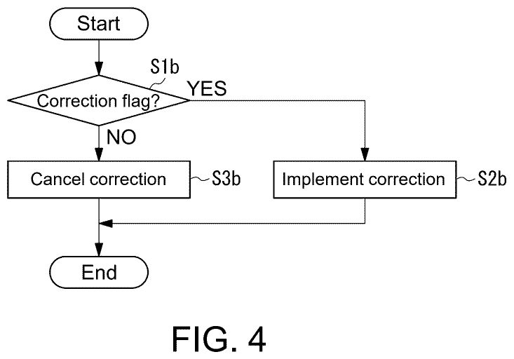

Next, the operation of the wiping device A according to the present embodiment will be described with reference to FIG. 2 to FIG. 4.

In the wiping device A, the wiper blade 1d on the driver's side performs wiping operation on the wiped surface W by the first wiper drive control unit 5d controlling the rotation of the motor 4d on the driver's side based on the control program. Moreover, in the wiping device A, the wiper blade 1p on the passenger's side performs wiping operation on the wiped surface W by the second wiper drive control unit 5p controlling the rotation of the motor 4p on the passenger's side based on the control program.

Moreover, in the wiping device A, the control information of the first wiper drive control unit 5d and the control information of the second wiper drive control unit 5p are mutually shared through a pair of communication circuits 12d, 12p. Through the sharing of control information, the wiper blade 1d on the driver's side and the wiper blade 1p on the passenger's side perform synchronized wiping operation (opposed wiping operation or parallel wiping operation). That is, the wiping control of the wiper blade 1d on the driver's side by the first wiper drive control unit 5d and the wiping control of the wiper blade 1p on the passenger's side by the second wiper drive control unit 5p are substantially the same.

Moreover, among the pair of wiper drive control units 5d, 5p, the CPU 11d on the driver's side corresponding to the wiper blade 1d on the driver's side performs load evaluation process of the motor 4d on the driver's side according to the flowchart shown in FIG. 2. The load evaluation process is a control process performed at the initial stage in the wiping control of the wiper blade 1d on the driver's side by the CPU 11d on the driver's side.

In the load evaluation process, the CPU 11d on the driver's side estimates the load (motor load) of the motor 4d on the driver's side that drives the wiper blade 1d on the driver's side based on the angle signal and other inputs from the angle detection circuit 8d (step S1). That is, the CPU 11d on the driver's side estimates the load of the motor 4d on the driver's side that drives, among the pair of wiper blades 1d, 1p, the wiper blade 1d on the driver's side, which moves first at operation start, as the load estimation amount.

Then, the CPU 11d on the driver's side determines whether the estimation value of the motor load (load estimation value Ld) exceeds a predetermined load threshold value Lr (step S2). The load threshold value Lr is a control parameter previously stored in the ROM 9d.

Here, the load of the motor 4d on the driver's side depends on the frictional resistance of the wiped surface W. The load of the motor 4d on the driver's side, that is, the frictional resistance of the wiped surface W, becomes a relatively large value when the wiped surface W is in a dry state, and in contrast, becomes a relatively small value when the wiped surface W is in a wet state.

In the case where the determination in step S2 is “Yes”, that is, when the load estimation value Ld exceeds the load threshold value Lr and the wiped surface W is in a dry state, the CPU 11d on the driver's side sets “1” to a DRY flag, which is set in the RAM 10d at startup (step S3). On the other hand, in the case where the determination in step S2 is “No”, that is, when the load estimation value Ld is equal to or below the load threshold value Lr and the wiped surface W is in a wet state, the CPU 11d on the driver's side, sets “0” to the DRY flag (step S4).

When the load evaluation process is completed in this manner, the CPU 11d on the driver's side performs setting process of a correction flag set in the RAM 10d together with the DRY flag at startup. In this setting process, the CPU 11d on the driver's side determines a set value (1 or 0) of the DRY flag as a result of the load evaluation process described above (step S1a).

In the case where the determination in step S1a is “Yes”, that is, when “1” is set to the DRY flag, the CPU 11d on the driver's side, sets “1” to the correction flag (step S2a). On the other hand, in the case where the determination in step S1a is “No”, that is, when “0” is set to the DRY flag, the CPU 1ad on the driver's side, sets “0” to the correction flag (step S3a).

When the setting process of the correction flag is completed in this manner, the CPU 11d on the driver's side performs correction process of the upper inversion position PUd of the wiper blade 1d on the driver's side by referring to the set value of the correction flag. That is, the CPU 11d on the driver's side determines the set value (1 or 0) of the correction flag (step S1b).

Then, in the case where the determination in step S1b is “Yes”, that is, when “1” is set to the correction flag, the CPU 11d on the driver's side, implements correction of the upper inversion position PUd of the wiper blade 1d on the driver's side (step S2b). That is, the CPU 11d on the driver's side corrects the upper inversion position PUd to a correction upper inversion position PUd1, PUp1 (refer to FIG. 1) in a direction closer to the lower inversion position PLd such that the wiper blade 1d on the driver's side does not interfere with the pillar of the vehicle by overrunning from the predetermined upper inversion position PUd.

On the other hand, in the case where the determination in step S1b is “No”, that is, when “0” is set to the correction flag, the CPU 11d on the driver's side, cancels the correction of the upper inversion position PUd (step S3b). That is, the CPU 11d on the driver's side returns the upper inversion position PUd of the wiper blade 1d on the driver's side to the predetermined upper inversion position PUd.

Furthermore, the CPU 11p on the passenger's side refers to the set value of the correction flag by accessing the RAM 10d on the driver's side through the communication circuit 12p on the passenger's side. That is, the CPU 11p on the passenger's side performs correction process of the upper inversion position PUp of the wiper blade 1p on the passenger's side by obtaining the set value of the correction flag from the RAM 10d on the driver's side as control information to be shared.

Specifically, the CPU 11p on the passenger's side corrects the upper inversion position PUp to a correction upper inversion position PUd1, PUp1 in a direction closer to the lower inversion position PLp such that the wiper blade 1p on the passenger's side does not interfere with the pillar of the vehicle by overrunning from the predetermined upper inversion position PUp.

In this manner, the wiping device A according to the present embodiment includes a pair of wiper blades 1d, 1p that reciprocate on the wiped surface W between the lower inversion positions PLd, PLp and the upper inversion positions PUd, Pup; a pair of motors 4d, 4p that drive the pair of wiper blades 1d, 1p respectively; and a pair of wiper drive control units 5d, 5p (control unit) that control the pair of motors 4d, 4p.

Moreover, in the wiping device A, the pair of wiper drive control units 5d, 5p (control unit) estimate the load of the motor 4d on the driver's side (one of the motors) that drives, among the pair of wiper blades 1d, 1p, the wiper blade 1d on the driver's side (one of the wiper blades) that moves first at operation start as a load estimation amount, and correct the upper inversion positions PUd, PUp to the correction upper inversion positions PUd1, PUp1 in a direction closer to the lower inversion positions PLd, PLp based on the load estimation amount.

According to the embodiment, it is possible to provide a wiping device A capable of suppressing overrun of the pair of wiper blades 1d, 1p due to changes in the state of the wiped surface W. Therefore, according to the embodiment, it is possible to effectively suppress interference between the pair of wiper blades 1d, 1p and the pillar of the vehicle due to changes in the state of the wiped surface W.

Moreover, in the wiping device A, the pair of wiper drive control units 5d, 5p (control unit) are provided as a pair corresponding to the pair of motors 4d, 4p, and share control information with each other. According to the embodiment, even in the case where the first wiper drive control unit 5d and the second wiper drive control unit 5p are individually provided for each of the pair of wiper blades 1d, 1p, it is possible to accurately suppress overrun of the pair of wiper blades 1d, 1p.

Moreover, in the wiping device A, the pair of wiper drive control units 5d, 5p (control unit) correct the upper inversion positions PUd, PUp in a direction closer to the lower inversion positions PLd, PLp in the case where the load estimation amount Ld is greater than a predetermined load threshold value Lr. According to the embodiment, it is possible to accurately suppress overrun of the pair of wiper blades 1d, 1p.

Moreover, in the wiping device A, one of the wiper blades is the wiper blade 1d on the driver's side provided on the driver's side of the vehicle. That is, the wiping device A corrects the upper inversion positions PUd, PUp based on the load of the motor 4d on the driver's side corresponding to the wiper blade 1d on the driver's side that moves ahead of the wiper blade 1p on the passenger's side at operation start. According to the embodiment, it is possible to more accurately suppress overrun of the pair of wiper blades 1d, 1p.

Moreover, in the wiping device A, the pair of wiper drive control units 5d, 5p (control unit) correct the upper inversion positions PUd, PUp in the case where the reciprocating motion is an opposed wiping operation, that is, in the case where the pair of wiper blades 1d, 1p reciprocate in the opposite manner. According to the embodiment, it is possible to accurately suppress overrun of the pair of wiper blades 1d, 1p in the case where the pair of wiper blades 1d, 1p reciprocate in the opposite manner.

What is claimed is:

1. A wiping device, comprising:
a pair of wiper blades that reciprocate between a lower inversion position and an upper inversion position on a wiped surface;
a pair of motors that drive the pair of wiper blades respectively; and
a control unit that controls the pair of motors,
wherein the control unit estimates a load of one of the motors that drives, among the pair of wiper blades, one of the wiper blades that moves first at operation start as a load estimation amount, and corrects the upper inversion position in a direction closer to the lower inversion position based on the load estimation amount.

2. The wiping device according to claim 1, wherein the control unit is provided in a pair corresponding to the pair of motors, and shares control information with each other.

3. The wiping device according to claim 1, wherein the control unit corrects the upper inversion position in a case where the load estimation amount is greater than a predetermined load threshold value.

4. The wiping device according to claim 2, wherein the control unit corrects the upper inversion position in a case where the load estimation amount is greater than a predetermined load threshold value.

5. The wiping device according to claim 1, wherein one of the wiper blades is provided on a driver's side in a vehicle.

6. The wiping device according to claim 2, wherein one of the wiper blades is provided on a driver's side in a vehicle.

7. The wiping device according to claim 1, wherein the control unit corrects the upper inversion position in a case where the wiper blades perform opposed wiping operation.

8. The wiping device according to claim 2, wherein the control unit corrects the upper inversion position in a case where the wiper blades perform opposed wiping operation.
